(19) United States
(12) Patent Application Publication
(10) Pub. No.: US 2021/0376406 A1
(43) Pub. Date: Dec. 2, 2021

(54) SOLID-STATE BATTERY MODULE AND SOLID-STATE BATTERY CELL

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/327,779

(22) Filed: May 24, 2021

(30) Foreign Application Priority Data
May 29, 2020 (JP) 2020-093860

(51) Int. Cl. H01M 10/658; H01M 50/209

(52) U.S. Cl. CPC H01M 10/658; H01M 50/209

(57) ABSTRACT

To provide a solid-state battery module capable of easily performing positioning of solid-state battery cells and preventing misalignment of a laminated body, and the solid-state battery cells. A solid-state battery module 1 includes: a plurality of solid-state battery cells 10, each including a solid-state battery 11 and an outer sheath 12 that accommodates the solid-state battery 11; an insulating member 14; and a mounting plate 4 that mounts the plurality of solid-state battery cells 10. The solid-state battery 11 includes a laminated body 110 including a negative electrode layer, a solid electrolyte layer, and a positive electrode layer, and a collector tab 13, and the insulating member 14 is provided on a side face other than a side face on which the collector tab 13 of the laminated body 110 is provided.

This application is based on and claims the benefit of priority from Japanese Patent Application No. 2020-093860, filed on 29 May 2020, the content of which is incorporated herein by reference.

### BACKGROUND OF THE INVENTION

### Field of the Invention

The present invention relates to a solid-state battery module and a solid-state battery cell.

### Related Art

In recent years, the demand for batteries with high capacity and high output is rapidly expanding due to the popularization of various types of electrical and electronic devices of all sizes, such as automobiles, personal computers, and mobile telephones.

Examples of such batteries include a liquid-based battery cell in which an organic electrolytic solution is used as an electrolyte between a positive electrode and a negative electrode, and a solid-state battery cell in which a flame-retardant solid electrolyte is used instead of an electrolyte of an organic electrolytic solution.

As such batteries, a laminated cell-type battery is known which is composed of rectangular parallelepiped cells wrapped with a laminate film and sealed in a plated shape. In applications such as EV and HEV, a battery pack (hereinafter, such a battery pack may be described as a battery module or a solid-state battery module) in which a plurality of such battery cells of laminate cell-type are arranged and stored in a case is used.

By wrapping the battery in an outer sheath, it is possible to prevent intrusion of air into the battery (refer to, for example, Japanese Unexamined Patent Application, Publication No. 2012-169204).

Patent Document 1: Japanese Unexamined Patent Application, Publication No. 2012-169204

### SUMMARY OF THE INVENTION

As disclosed in Japanese Unexamined Patent Application, Publication No. 2012-169204, when a battery is wrapped and sealed with a film, it is common to wrap the battery with two films, join four sides of the films facing each other to provide a joint, and seal the film.

When the battery cell has such a joint, in order to form a battery module by stacking a plurality of battery cells, it is necessary to fasten the battery ceils to each other in consideration of the shape of the joint.

In a case of forming a battery module by stacking liquid-based battery cells, it will suffice if the battery module has a function of fastening the battery cell.

However, in a case of forming a solid-state battery module by stacking the solid-state battery cells, it is necessary to increase the restraining pressure of the solid-state battery cells, and there is a problem in that misalignment occurs in the stack of the solid-state battery cells due to the shape of the joint not being constant. Furthermore, positioning with reference to a laminated body contained is required for the conventional solid-state battery cell; however, since the laminated body cannot be visually recognized from the outside, positioning when forming the module is difficult.

The present invention has been made in view of the above, and an object thereof is to provide a solid-state battery module capable of easily performing positioning of solid-state battery ceils and preventing misalignment of a laminated body, and the solid-state battery cells.

A first aspect of the present invention is directed to a solid-state battery module including: a plurality of solid-state battery cells, each including a solid-state battery and an outer sheath that accommodates the solid-state battery; an insulating member; and a mounting plate that mounts the plurality of solid-state battery cells, in which the solid-state battery includes a laminated body including a negative electrode layer, a solid electrolyte layer, and a positive electrode layer, and a collector tab, and the insulating member is provided on a side face other than a side face on which the collector tab of the laminated body is provided.

According to the first aspect of the present invention, it is possible to provide a solid-state battery module capable of easily positioning the solid-state battery cells and preventing misalignment of the laminated body.

A second aspect of the present invention is an embodiment of the first aspect. In the second aspect, the insulating member is provided between the laminated body in the solid-state battery and the mounting plate.

According to the second aspect of the present invention, it is possible to easily perform positioning of the solid-state battery cells with reference to the mounting plate.

A third aspect of the present invention is an embodiment of the first aspect or the second aspect. In the third aspect, the insulating member is provided along a laminating direction of the laminated body.

According to the third aspect of the present invention, it is possible to position and fasten the laminated body on the insulating member to configure the solid-state battery module.

A fourth aspect of the present invention is an embodiment of any one of the first aspect to the third aspect. In the fourth aspect, a solid-state battery cell for use in the solid-state battery module includes: a solid-state battery; an insulating member; and an outer sheath that accommodates the solid-state battery and the insulating member, in which the solid-state battery includes a laminated body including a negative electrode layer, a solid electrolyte layer, and a positive electrode layer, and the insulating member is provided along a laminating direction of the laminated body.

According to the fourth aspect of the present invention, it is possible to provide solid-state battery cells constituting a solid-state battery module capable of preventing misalignment of the laminated body.

Since the solid-state battery ceils accommodate the insulating member in advance, it is possible to easily perform the positioning.

A fifth aspect of the present invention is an embodiment of the fourth aspect. In the fifth aspect, the outer sheath includes a bent portion formed by folding back one film so as to accommodate the solid-state battery, and a joint portion at which ends of the film facing each other are joined.

According to the fifth aspect of the present invention, since it is possible to configure the solid-state battery module without providing the joint between the insulating member and the mounting plate, it is possible to prevent misalignment of the laminated body. In addition, the volume energy density of the solid-state battery module can be improved.

A sixth aspect of the present invention is an embodiment of the fifth aspect. In the sixth aspect, the insulating member includes the joint portion having a predetermined thickness.

According to the sixth aspect of the present invention, since it is possible to adopt the joint as an insulating member, it is possible to reduce the time and cost required for assembly.

### BRIEF DESCRIPTION OF THE DRAWINGS

FIG. 1 is a perspective view of a solid-state battery module 1 according to the first embodiment;

FIG. 2 is a cross-sectional view taken along the line A-A in FIG. 1;

FIG. 3 is a cross-sectional view of a solid-state battery module 1a according to the second embodiment;

FIG. 4 is an enlarged cross-sectional view of FIG. 2;

FIG. 5 is a perspective view of a solid-state battery cell 10 according to the first embodiment;

FIG. 6A is a perspective view showing an example of a manufacturing method of the solid-state battery cell 10 according to the first embodiment;

FIG. 6B is a perspective view showing an example of a manufacturing method of the solid-state battery cell 10 according to the first embodiment;

FIG. 6C is a perspective view showing an example of a manufacturing method of the solid-state battery cell 10 according to the first embodiment;

FIG. 6D is a perspective view showing an example of a manufacturing method of the solid-state battery cell 10 according to the first embodiment; and

FIG. 7 is a cross-sectional view of a conventional solid-state battery module.

### DETAILED DESCRIPTION OF THE INVENTION

Embodiments of the present invention will be described below with reference to the drawings.

However, the following embodiments exemplify the present invention, and the present invention is not to be limited to the following embodiments.

### First Embodiment

### Solid-State Battery Module

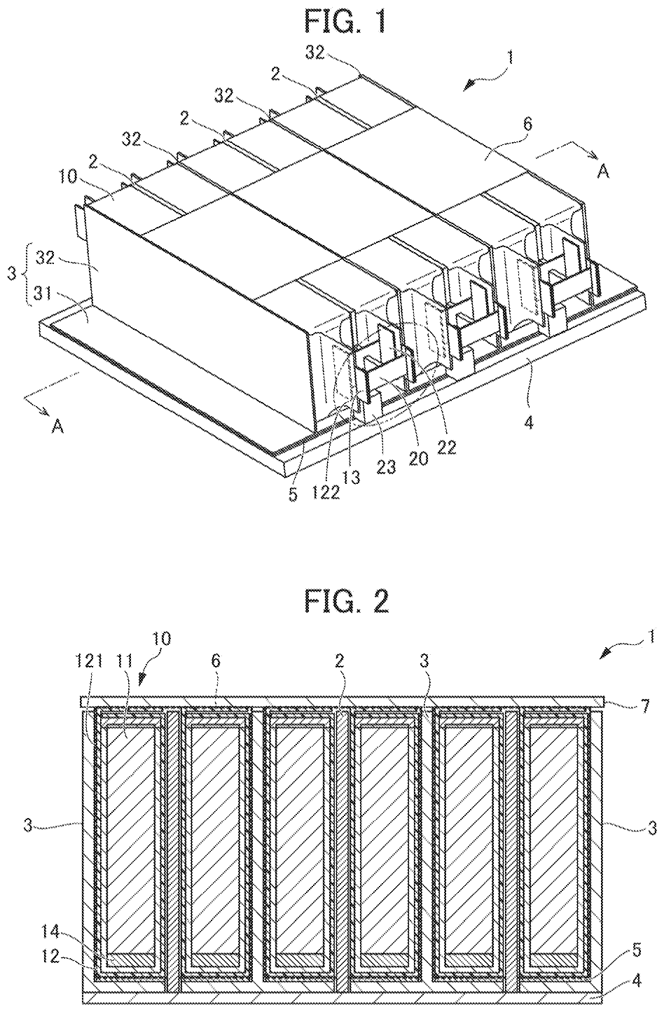

FIG. 1 is a perspective view showing an outline of a solid-state battery module 1 according to a first embodiment of the present invention.

As shown in FIG. 1, the solid-state battery module 1 includes a plurality of solid-state battery cells 10, a support 2, a cooling plate 3, a mounting plate 4, a vibration isolator 5, and a fastening film 6.

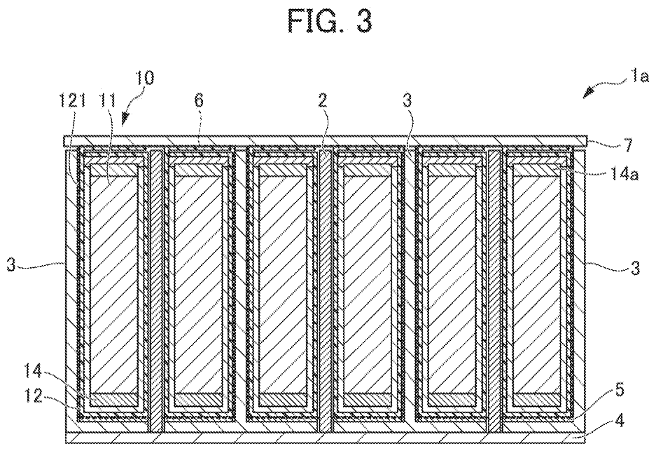

Although not shown in FIG. 1, the upper surface of the solid-state battery module 1 is coated with a top cover 7 as shown in FIG. 2.

The solid-state battery module 1 includes the plurality of solid-state battery cells 10 which are electrically connected to each other and stacked.

The plurality of solid-state battery cells 10 are mounted on the mounting plate 4.

Collector tabs 13 constituting the electrode of the solid-state battery cell 10 each extend from one end face of the plurality of solid-state battery cells 10.

The collector tabs 13 of the adjacent solid-state battery cell 10 are electrically connected by a bus bar energizing portion 20.

The detailed configuration of the solid-state battery cell 10 will be described later.

### Support

The support 2 is a plate-shaped member that supports the solid-state battery cell 10 and prevents the solid-state battery cell 10 from being damaged.

The support 2 includes the bus bar energizing portion 20, a collector tab support portion 22, and a mounting plate fastening portion 23.

The support 2 may further include, in an upper portion of the support 2 or any other portion thereof, a heat radiating part having a comb shape or a sawtooth shape, or a heat radiating unit formed as through holes.

By the heat radiating part increasing the surface area of the support 2, it is possible to effectively radiate heat generated from the solid-state battery cell 10.

The bus bar energizing portion 20 sur face-supports the collector tabs 13 or collector tab leads electrically connected to the collector tabs 13, and electrically connects the collector tabs 13 or the collector tab leads of adjacent solid state battery cells 10.

The collector tab support portion 22 surface-supports the collector tab 13 or the collector tab lead via the outer sheath 12.

This configuration can further effectively prevent damage to the solid-state battery cells 10, and makes it possible to collect, to the bus bar energizing portion 20, the electricity generated by the plurality of solid-state battery cells 10 connected to each other.

The mounting plate fastening portion 23 is disposed on both sides of the lower portion of the support 2, and fastens the support 2 to the mounting plate 4.

With the mounting plate fastening portion 23, the solid-state battery cell 10 can be effectively fastened, and damage to the solid-state battery cell 10 can be more effectively prevented.

The support 2 is held between adjacent solid-state battery cells 10.

The support 2 is in contact with the outer sheath 12 of the solid-state battery cell 10 to support the solid-state battery cell 10, thereby preventing the solid-state battery cell 10 from being damaged.

The material of the support 2 is not particularly limited, and a metal, a resin, or the like can be used.

For the support 2, a metal having a high thermal conductivity is preferably used.

Thus, heat generated from the solid-state battery cell 10 can be efficiently radiated.

### Cooling Plate

A cooling plate 3 contacts the solid-state battery ceil 10 to radiate heat generated from the solid-state battery cell 10.

The cooling plate 3 includes, for example, a battery cell mounting portion 31 disposed on a mounting surface of the solid-state battery cell 10, and a battery cell holding portion 32 extending upward from the battery cell mounting portion 31 and held between the solid-state battery cells 10.

In the present embodiment, the cooling plates 3 are each disposed at the end of the stacked solid-state battery ceils 10.

In addition to the above, the cooling plate 3 may be disposed on a mounting surface of the solid-state battery cell 10.

The material of the cooling plate 3 is not particularly limited, and is preferably a material having high thermal conductivity such as a metal.

### Mounting Plate

The mounting plate 4 mounts the plurality of solid-state battery cells 10.

The material of the mounting plate 4 is not particularly limited, and is preferably a material having a high thermal conductivity such as a metal.

This makes it possible to effectively prevent the solid-state battery cell 10 from being damaged, and to effectively radiate the heat generated from the solid-state battery cell 10.

### Vibration Isolator

The vibration isolator 5 is a member on which the plurality of solid-state battery cells 10 is mounted.

In the present embodiment, the vibration isolator 5 is disposed on the upper surface of the cooling plate 3 for each of the plurality of solid-state battery cells 10.

The plurality of solid-state battery cells 10 may be placed on the upper surface of the mounting plate 4 via the vibration isolator 5.

By mounting the plurality of solid-state battery cells 10 via the vibration isolator 5, it is possible to effectively prevent shaking of the solid-state battery cells 10.

As a material of the vibration isolator 5, a conventionally known material is used as a vibration isolating material, such as urethane rubber, silicone rubber, or the like.

### Fastening Film

The fastening film 6 fastens the plurality of solid-state battery cells 10.

The fastening film 6 can effectively prevent the solid-state battery cell 10 from being damaged.

The material of the fastening film 6 is not particularly limited, and examples thereof include paper, cloth, film (cellophane, OPP, acetate, polyimide, FVC, and the like), and an adhesive tape composed of a metal foil or the like.

### Top Cover

The top cover 7 covers the upper surface of the solid-state battery module 1, and corresponds to the lid of the solid-state battery module 1.

With the top cover 7, the electrical insulation of the solid-state battery module 1 is maintained.

By applying a predetermined pressure to the plurality of solid-state battery cells 10 from above the top cover 7, it is possible to position the laminated body 110 on the insulating member 14.

FIG. 2 is a cross-sectional view taken along the line A-A in FIG. 1.

As shown in FIG. 2, the solid-state battery cell 10 has the outer sheath 12 that accommodates a solid-state battery 11.

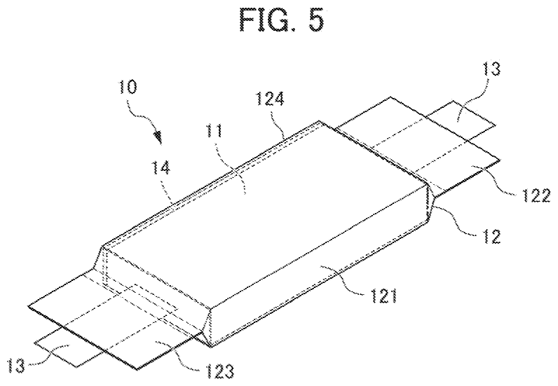

As shown in FIG. 4, the solid-state battery 11 includes the laminated body 110.

The insulating member 14 is disposed between the mounting plate 4 and the laminated body 110 along the laminating direction of the laminated body 110, as denoted by arrows in FIG. 4.

A surface in contact with a side of the outer sheath 12 close to the mounting plate 4 is a smooth surface having no step such as a joint. With such a configuration, by applying a predetermined pressure to the solid-state battery cell 10 from a side of the top cover 7, which is an upper side, it is possible to perform positioning by directly or indirectly bringing into contact the laminated body 110 which is accommodated in the outer sheath 12 and invisible from the outside, and the insulating member 14 and the mounting plate 4 with each other.

FIG. 4 is an enlarged view of a main part in FIG. 2.

As shown in FIG. 4, in the solid-state battery module 1, the laminated body 110 of the plurality of solid-state battery cells 10 are laminated in the identical direction, and the ends are aligned and fastened.

With such a configuration, it is possible to ensure the input-output voltage of the solid-state battery module 1, and it is possible to prevent cracking of the electrode.

In addition, the positions of the collector tabs 13 can be uniformly aligned, and the yield in manufacturing the solid-state battery module 1 can be improved.

### Solid-State Battery Cell

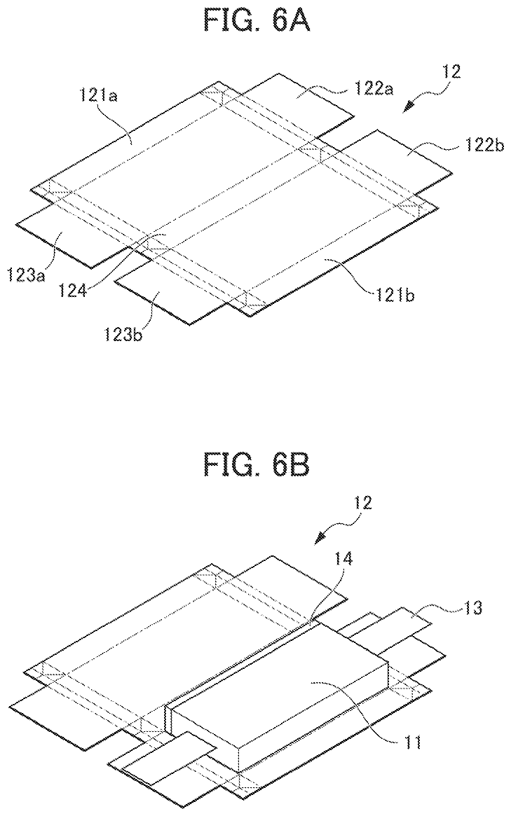

As shown in FIG. 5, the solid-state battery cell 10 includes the solid-state battery 11, the outer sheath 12, the collector tab 13, and the insulating member 14.

In the present embodiment, the insulating member 14 is accommodated in the outer sheath 12, and is disposed on either side of the solid-state battery 11.

The insulating member 14 may be disposed outside of the solid-state battery cell 10, and may be configured separately from the solid-state battery cell 10.

It should be noted that, in this specification, “battery” does not include the outer sheath, and indicates a configuration in which the collecting tab lead is connected to a laminated body described below.

“Battery cell” indicates a configuration including a “battery” and an outer sheath.

As shown in FIG. 4, the solid-state battery 11 includes the laminated body 110 in which a plurality of negative electrode layers 114, solid electrolyte layers 117, and positive electrode layers 111 are laminated in this order.

It should be noted that, depending on the cell configuration, the positive electrode layer 111 may be disposed on a side close to the outer sheath 12.

In each of the negative electrode layers 114, negative electrode active material layers 116 are laminated on both surfaces of a negative electrode collector 115.

In the positive electrode layer 111, positive electrode active material layers 112 are laminated on both surfaces of a positive electrode collector 113.

These may be separate layers, or the collector and the active material layer may be integrated.

### Negative Electrode Active Material Layer

The negative electrode active material constituting the negative electrode active material layer 116 is not particularly limited, and a known material can be applied as the negative electrode active material of a solid-state battery.

There is no particular limitation in the composition thereof, and a solid electrolyte, a conductive auxiliary agent, a binder, or the like may be contained.

Examples of the negative electrode active material include lithium metal, lithium alloys such as Li—Al alloys and Li—In alloys, lithium titanates such as Li₄Ti₅O₁₂, carbon materials such as carbon fibers and graphites, and the like.

### Negative Electrode Collector

The negative electrode collector 115 is not particularly limited, and a known collector which can be used for a negative electrode of a solid-state battery can be applied.

Examples of the material of the negative electrode collector 115 include nickel, copper, stainless steel, and the like.

In addition, examples of the forms of the negative pole collector 115 include foil-like, sheet-like, mesh-like, foam-like, etc. Thereamong, foil-like is preferred.

### Positive Electrode Active Material Layer

The positive electrode active material constituting the positive electrode active material layer 112 is not particularly limited, and a known material can be applied as the positive electrode active material of a solid-state battery.

There is no particular limitation on the composition thereof, and a solid electrolyte, a conductive auxiliary agent, a binder, and the like may be contained.

As the positive electrode active material, a material capable of releasing and storing ions (e.g., lithium ions) can be appropriately selected and used.

Specific examples of the positive electrode active material include, for example, lithium cobaltate (LiCoCO₂), lithium nickelate (LiNiO₂), LiNiₚMn_{q}COᵣO₂ (p+q+r=1), LiNiₚAl_{q}CoᵣO₂ (p+q+r=1), lithium manganate (LiMn₂O₄), hetero-element-substituted Li—Mn spinels represented by Li₁₊ₓMn_{2-x-y}MyO₄ (x+y=2, M=at least one selected from Al, Mg, Co, Fe, Ni, and Zn), metallic lithium phosphate (LiMPO₄, M=at least, one selected from Fe, Mn, Co, and Ni), and the like.

### Positive Electrode Collector

The positive electrode collector 113 is not particularly limited as long as it has a function of collecting the current of the positive electrode layer.

Examples of the material of the positive electrode collector 113 include aluminum, an aluminum alloy, stainless steel, nickel, iron, and titanium.

Thereamong, aluminum, aluminum alloy, and stainless steel are preferred.

Examples of the shape of the positive pole collector 113 include foil-like shape, sheet-like shape, mesh-like shape, foam-like shape, and the like.

Thereamong, foil-like shape is preferred.

### Solid Electrolyte Layer

The solid electrolyte layer 117 is laminated between the negative electrode layer 114 and the positive electrode layer 111, and contains at least a solid electrolyte material.

The solid electrolyte is, for example, a solid electrolyte layer formed in layers.

Ion conduction (e.g., lithium-ion conduction) between the positive electrode active material and the negative electrode active material can be performed via the solid electrolyte material contained in the solid electrolyte layer.

### Outer Sheath

The outer sheath 12 is a package which is in close contact with the solid-state battery 11 and fastened therewith, and accommodates the solid-state battery 11.

Since the solid-state battery 11 is hermetically accommodated by the outer sheath 12, the entry of air into the solid-state battery 11 can be prevented.

The outer sheath 12 is formed of a film.

The above film is not particularly limited as long as it is a film capable of forming the outer sheath 12 accommodating the solid-state battery 11.

It is preferable that the film forming the outer sheath 12 is a film such that airtightness can be imparted to the outer sheath 12

One film forming the outer sheath 12 may be a single layer film or a laminate including a plurality of layers.

The film for forming the outer sheath 12 preferably includes a barrier layer made of, for example, an inorganic thin film such as aluminum foil, or an inorganic oxide thin film such as silicon oxide or aluminum oxide.

By providing the outer sheath 12 with the barrier layer, it is possible to impart airtightness to the outer sheath 12.

It is preferable that the film forming the outer sheath 12 includes a seal layer made of a thermoplastic resin such as polyethylene resin.

Sealing layers laminated on the film are opposed to each other and welded to each other, whereby the films can be bonded to each other. Therefore, a step of applying an adhesive becomes unnecessary.

It should be noted that the film forming the outer sheath 12 may not be provided with a seal layer.

It is also possible to form the outer sheath 12 by bonding the films together by an adhesive.

Examples of the film for forming the outer sheath 12 include a laminate in which a base layer made of polyethylene terephthalate, polyethylene naphthalate, nylon, polypropylene, or the like, the barrier layer described above, and the seal layer described above are laminated.

These layers may be laminated using a conventionally known adhesive, or may be laminated by an extrusion coating method or the like.

The preferred thickness of the film forming the outer sheath 12 varies depending on the material used for the film. However, it is preferably 50 μm or more, and more preferably 100 μm or more. The preferred thickness of the film forming the outer sheath 12 is preferably 700 μm or less, and more preferably 200 μm or less.

As shown in FIG. 5, the outer sheath 12 includes a bent portion 124 formed by folding back one film on one end face of the solid-state battery 11 so as to accommodate the solid-state battery 11 having a substantially rectangular parallelepiped shape.

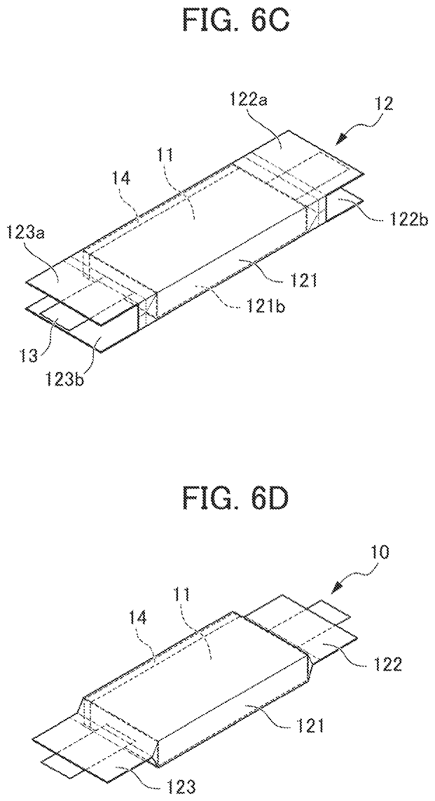

Furthermore, as shown in FIGS. 6A to 6D, the outer sheath 12 includes joint portions 121a and 121b in which the ends facing each other are joined, joint portions 122a and 122b, and joint portions 123a and 123b.

Furthermore, the outer sheath 12 includes the bent portion 124 and side faces facing each other.

When the outer sheath 12 wraps and seals the solid-state battery 11, it is common to wrap the solid-state battery 11 with two films and seal by joining the four sides of the film facing each other.

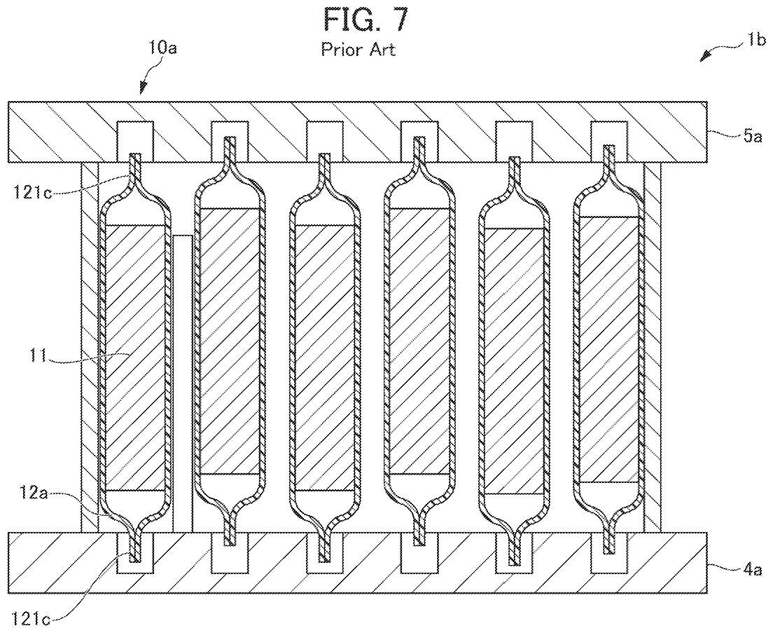

FIG. 7 is a cross-sectional view showing an outline of a solid-state battery module 1b constituted by a solid-state battery cell 10a having a conventional outer sheath 12a.

As shown in FIG. 7, in the conventional outer sheath 12a that seals the solid-state battery 11 by joining four sides of the films facing each other, joint portions 121c are each disposed between a mounting plate 4a and a top cover 5a.

Since the shape of the joint portion 121c formed of the film is not constant, the mounting plate 4a and the top cover 5a need to have a shape in consideration of the shape of the joint portion 121c.

However, as shown in FIG. 7, since the shape of the bonding portion 121c is not constant, misalignment of the laminated body may occur. Since the solid-state battery ceil 10a is fastened by applying a high confining pressure, when misalignment of the laminated body accommodated in the solid-state battery cell 10a occurs, the input-output voltage of the solid-state battery module cannot be ensured, and furthermore, there is a risk that electrode plate cracking occurs.

In the outer sheath 12 according to the present embodiment, since one film includes the above configuration formed by being folded back at one end face of the solid-state battery 11, it is possible to configure without providing any joint at the mounting plate 4.

Thus, it is possible to configure the solid-state battery module 1 while preventing the laminating misalignment of the laminated body 110.

### Collector Tab

The collector tabs 13 are each configured such that the negative electrode collector and the positive electrode collector in the solid-state battery 11 are drawn out from one end face and the other end face of the solid-state battery 11.

In the present embodiment, the collector tabs 13 may be drawn out from the respective collectors.

That is, the collector tabs 13 may be members in which the respective collectors extend or may be members different from the collectors.

The material that can be used for the collector tab 13 is not particularly limited, and the same material as that conventionally used for a solid-state battery can be used.

### Insulating Member

The insulating member 14 is disposed on a side face other than the side face where the collector tab 13 of the laminated body 110 is disposed.

As shown in FIG. 4, the insulating member 14 is preferably disposed along the laminating direction of the laminated body 110.

As shewn in FIG. 4, by providing the insulating member 14, it is possible to align the position of the ends of each layer of the laminated body 110 to configure the solid-state battery module 1 with the laminating direction of the laminated body 110 in the plurality of solid-state batteries 11 in the same direction.

The material of the insulating member 14 is not particularly limited as long as the material has rigidity and ensures insulation to the laminated body 110.

As the insulating member 14, for example, a resin material such as polypropylene (PP) resin and polyphenylene sulfide (PPS) resin, a fiber material manufactured by pulp or the like, a metal material in which a member of a resin having an insulating property or the like on its surface is disposed, or the like can be used.

In addition, a part of the outer sheath 12, for example, the joint portions 121a and 121b, may have a predetermined thickness can be used as the insulating member 14.

### Method of Manufacturing Solid-State Battery Cell 10

As shown in FIGS. 6A to 6D, the method of manufacturing the solid-state battery cell 10 includes, for example, the steps of: manufacturing the outer sheath 12 (FIG. 6A); mounting the solid-state battery 11 and the insulating member 14 on the outer sheath 12 (FIG. 6B); folding back the outer sheath 12 in a cylindrical shape (FIG. 6C); and welding other joint portions to seal (FIG. 6D).

FIG. 6A: In the step of manufacturing the outer sheath 12, one outer sheath 12 is prepared by forming a folding line or the like in advance.

The folding line and the like are formed according to the shape and size of the solid-state battery 11 to be accommodated in the outer sheath 12.

FIG. 6B: The step of mounting the solid-state battery 11 and the insulating member 14 on the outer sheath 12 includes mounting the solid-state battery 11 along the folding line formed on the outer sheath 12.

Then, the step further includes mounting the insulating member so as to be brought into contact with the solid-state battery 11 along the laminating direction of the laminated body 110 of the solid-state battery 11.

It should be noted that, although the insulating member 14 is disposed on the side of the bent portion 124 in FIGS. 6B to 6D, the present invention is not limited thereto, and the insulating member 14 may be disposed on the side of the joint portions 121a and 121b.

FIG. 6C: The step of folding back and joining the outer sheath 12 into a cylindrical shape includes folding back the outer sheath 12 into a cylindrical shape so as to accommodate the solid-state batteries 11 and the insulating members 14 therein, and welding and joining the joint portions 121a and 121b having seal layers formed on their inner surfaces by applying heat from the outside.

FIG. 6D: The step of welding and sealing the other joint portions includes sandwiching the collector tab 13 to join the joint portions 122a, 122b, 123a, and 123b.

As a result, it is possible to prevent the formation of dead spaces by reducing the joint portion of the outer sheath 12 in which the films are joined to each other, and to effectively improve the volume energy density of the solid-state battery cell 10.

When the solid-state battery 11 is a solid-state battery, it is preferable to evacuate the interior of the outer sheath 12 prior to the step shown in FIG. 6D.

As a result, atmospheric pressure is uniformly applied to the end surface of the battery cell in which the bent portion 124 is formed, and the solid-state battery can be fastened more firmly.

Furthermore, it is possible to improve the durability by preventing laminating misalignment and electrode cracking of the solid-state battery due to vibration.

It should be noted that the solid-state battery 11 and the insulating member 14 may be inserted into the outer sheath 12 formed in a cylindrical shape after folding back the outer sheath 12 shown in FIG. 6C into a cylindrical shape and joining.

However, according to the above procedure, it is possible to accommodate the battery while further reducing or eliminating gaps by mounting the solid-state battery 11 and the insulating member 14 on the film where the folding line is formed, and by sealing the seal portions to each other.

Thus, according to the above procedure, it is possible to effectively improve the volume energy density of the solid-state battery cell 10.

Hereinafter, another embodiment of the present invention will be described.

Descriptions for configurations which are identical to the first embodiment may be omitted.

### Second Embodiment

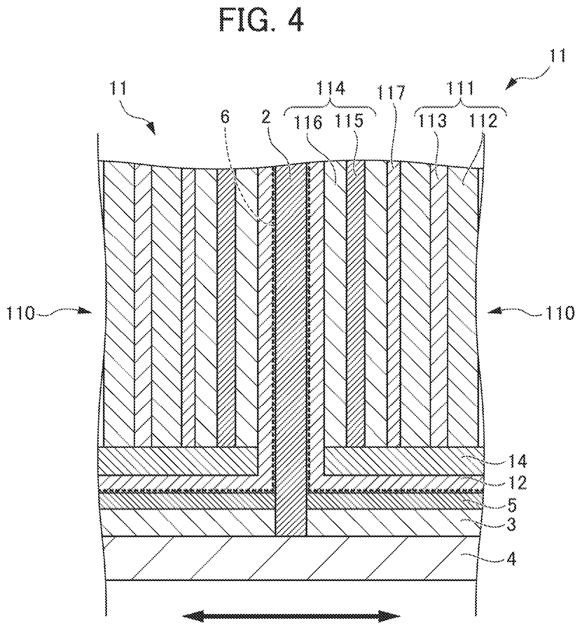

FIG. 3 is a diagram showing a solid-state battery module la according to the second embodiment.

FIG. 3 corresponds to a cross-sectional view along the line A-A in FIG. 1.

In the solid-state battery module la according to the present embodiment, not only the insulating members 14 are disposed between the mounting plate 4 and the solid-state battery 11, but also insulating members 14a are disposed between the top cover 7 and the solid-state battery 11.

With such a configuration, by pressing the plurality of solid-state battery cells 10 at a predetermined pressure from above the top cover 7, it is possible to more reliably position the laminated body 110.

In the foregoing, preferred embodiments of the present disclosure have been described. However, the above-described embodiments are not intended to limit the present invention. The scope of the present invention further encompasses appropriate modifications that are made in a range not impeding the effects of the present invention.

In the above embodiments, the insulating members 14 and 14a are disposed inside the outer sheath 12 in FIGS. 2 and 3; however, the present invention is not limited thereto.

The insulating members 14 and 14a may be disposed between the laminated body 110 and the mounting plate 4, or between the laminated body 110 and the top cover 7.

Therefore, the insulating member 14 may be disposed outside the outer sheath 12.

In the above embodiments, the insulating member 14 is disposed between the laminated body 110 and the mounting plate 4 in FIG. 2. Furthermore, in FIG. 3, in addition to the above, the insulating member 14a is disposed between the laminated body 110 and the top cover 7. However, the present invention is not limited thereto.

A configuration including only the insulating member 14a disposed between the laminated body 110 and the top cover 7 is also encompassed in the scope of the present invention.

It should be noted that it is most preferable to include both the insulating members 14 and 14a as shown in FIG. 3.

The insulating member 14 may not be in direct contact with the laminated body 110 or the mounting plate 4.

As shown in FIG. 2, the insulating member 14 may be in contact with the laminated body 110, and the mounting plate 4 or the top cover 7 indirectly via another member such as the vibration isolator 5 or a protective material.

In the first embodiment, a configuration is described in which the insulating member 14 is disposed only between the laminated body 110 and the mounting plate 4; however, the present invention is not limited thereto.

The insulating member 14 may also be disposed between the laminated body 110 and the fastening film 6, for example.

With such a configuration, misalignment of the laminated body 110 can be more preferably prevented.

### EXPLANATION OF REFERENCE NUMERALS

1, 1a solid-state battery module
10 solid-state battery cell
11 solid-state battery
110 laminated body
111 positive electrode layer
114 negative electrode layer
117 solid electrolyte layer
12 outer sheath
121a, 121b, 122a, 122b, 123a, 123b joint
124 bent portion
13 collector tab
14, 14a insulating member
4 mounting plate

What is claimed is:

1. A solid-state battery module comprising:
a plurality of solid-state battery cells, each including a solid-state battery and an outer sheath that accommodates the solid-state battery;
an insulating member; and
a mounting plate that mounts the plurality of solid-state battery cells,
wherein the solid-state battery includes a laminated body including a negative electrode layer, a solid electrolyte layer, and a positive electrode layer, and a collector tab, and
the insulating member is provided on a side face other than a side face on which the collector tab of the laminated body is provided.

2. The solid-state battery module according to claim 1, wherein the insulating member is provided between the laminated body in the solid-state battery and the mounting plate.

3. The solid-state battery module according to claim 1, wherein the insulating member is provided along a laminating direction of the laminated body.

4. A solid-state battery cell for use in the solid-state battery module according to claim 1, comprising:
a solid-state battery;
an insulating member; and
an outer sheath that accommodates the solid-state battery and the insulating member,
wherein the solid-state battery includes a laminated body including a negative electrode layer, a solid electrolyte layer, and a positive electrode layer, and
the insulating member is provided along a laminating direction of the laminated body.

5. The solid-state battery cell according to claim 4, wherein the outer sheath includes a bent portion formed by folding back one film so as to accommodate the solid-state battery, and a joint portion at which ends of the film facing each other are joined.

6. The solid-state battery cell according to claim 5, wherein the insulating member includes the joint portion having a predetermined thickness.
